(19) United States
(12) Patent Application Publication
(10) Pub. No.: US 2025/0016759 A1
(43) Pub. Date: Jan. 9, 2025

(54) REFERENCE SIGNAL CONFIGURATION METHOD AND APPARATUS

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/712,386

(22) PCT Filed: Nov. 26, 2021
(86) PCT No.: PCT/CN2021/133674

§ 371 Date: May 22, 2024

(51) Int. Cl. H04W 72/044; H04L 5/00

(52) U.S. Cl. CPC H04W 72/046; H04L 5/0048

(57) ABSTRACT

Embodiments of the present application disclose a reference signal configuration method and apparatus. The method comprises: receiving reference signal configuration information transmitted by a network device; and according to the reference signal configuration information, determining a beam corresponding to a reference signal. Therefore, the network device can transmit a specific beam on a service link under the condition that the angle of beam generation of a relay device is not indicated directly by means of signaling, and thus, the extra signaling overhead is reduced, and the communication efficiency of a system is improved.

### CROSS-REFERENCE TO RELATED APPLICATION

The application is a U.S. National Stage of International Application No. PCT/CN2021/133674 filed on Nov. 26, 2021, the entire content of which is incorporated herein by reference for all purposes.

### TECHNICAL FIELD

The present application relates to the technical field of communication, and in particular, to a reference signal configuration method and apparatus.

### BACKGROUND

In the related art, a smart repeater needs to perform beam sweeping on a service link to ensure that the terminal can search for the most suitable beam, the information of the optimal beam fed back by the terminal will be forwarded to the base station via the smart repeater, and the base station obtains feedback information from the terminal after demodulating the received signal, and indicates the beam on the service link to the smart repeater according to the feedback information.

### SUMMARY

The embodiment of the first aspect of the present application proposes a reference signal configuration method, the method is executed by a relay device, and the method includes:
receiving configuration information of a reference signal sent by a network device; and
determining a beam corresponding to the reference signal according to the configuration information of the reference signal.

The embodiment of the second aspect of the present application proposes a reference signal configuration method, the method is executed by a network device, and the method includes:
sending configuration information of a reference signal to a relay device;
where the configuration information of the reference signal is used to determine a beam corresponding to the reference signal.

The embodiment of the third aspect of the present application proposes a reference signal configuration apparatus, the apparatus is applied to a relay device, and the apparatus includes:
a transceiver unit, configured to receive configuration information of a reference signal sent by a network device; and
a processing unit, configured to determine a beam corresponding to the reference signal according to the configuration information of the reference signal.

The embodiment of the fourth aspect of the present application proposes a reference signal configuration apparatus, the apparatus is applied to a network device, and the apparatus includes:
a transceiver unit, configured to send configuration information of a reference signal to a relay device;
where the configuration information of the reference signal is used to determine a beam corresponding to the reference signal.

The embodiment of the fifth aspect of the present application proposes a communication apparatus, the apparatus includes a processor and a memory, a computer program is stored in the memory, and the processor executes the computer program stored in the memory, so that the apparatus performs the reference signal configuration method described in the embodiment of the first aspect above.

The embodiment of the sixth aspect of the present application proposes a communication apparatus, the apparatus includes a processor and a memory, a computer program is stored in the memory, and the processor executes the computer program stored in the memory, so that the apparatus performs the reference signal configuration method described in the embodiment of the second aspect above.

The embodiment of the seventh aspect of the present application proposes a communication apparatus, the apparatus includes a processor and an interface circuit, the interface circuit is configured to receive code instructions and transmit them to the processor, and the processor is configured to run the code instructions to make the apparatus execute the reference signal configuration method described in the embodiment of the first aspect above.

The embodiment of the eighth aspect of the present application proposes a communication apparatus, the apparatus includes a processor and an interface circuit, the interface circuit is configured to receive code instructions and transmit them to the processor, and the processor is configured to run the code instructions to make the apparatus execute the reference signal configuration method described in the embodiment of the second aspect above.

The embodiment of the ninth aspect of the present application proposes a computer-readable storage medium for storing instructions, and when the instructions are executed, the reference signal configuration method described in the embodiment of the first aspect above is implemented.

The embodiment of the tenth aspect of the present application proposes a computer-readable storage medium for storing instructions, and when the instructions are executed, the reference signal configuration method described in the embodiment of the second aspect above is implemented.

The embodiment of the eleventh aspect of the present application proposes a computer program that, when running on a computer, causes the computer to execute the reference signal configuration method described in the embodiment of the first aspect.

The embodiment of the twelfth aspect of the present application proposes a computer program that, when running on a computer, causes the computer to execute the reference signal configuration method described in the embodiment of the second aspect.

In the reference signal configuration method and apparatus provided in the embodiments of the present application, by receiving the configuration information of the reference signal sent by the network device, and determining the beam corresponding to the reference signal according to the configuration information of the reference signal, a specific beam can be sent on the service link in the case that the network device does not directly indicate the beam forming angle to the relay device through signaling, which saves the overhead of additional signaling and improves the communication efficiency of the system.

Additional aspects and advantages of the present application will be set forth in part in the following description, and in part will be obvious from the description, or may be learned by practice of the present application.

### BRIEF DESCRIPTION OF THE DRAWINGS

In order to more clearly illustrate the technical solutions in the embodiments of the present application or the background art, the following will describe the drawings that need to be used in the embodiments of the present application or the background art.

FIG. 1 is a schematic structural diagram of a communication system provided by an embodiment of the present application;

FIG. 2 is a schematic flowchart of a reference signal configuration method provided in an embodiment of the present application;

FIG. 3 is a schematic flowchart of a reference signal configuration method provided in an embodiment of the present application;

FIG. 4 is a schematic flowchart of a reference signal configuration method provided in an embodiment of the present application;

FIG. 5 is a schematic flowchart of a reference signal configuration method provided in an embodiment of the present application;

FIG. 6 is a schematic flowchart of a reference signal configuration method provided in an embodiment of the present application;

FIG. 7 is a schematic flowchart of a reference signal configuration method provided in an embodiment of the present application;

FIG. 8 is a schematic flowchart of a reference signal configuration method provided in an embodiment of the present application;

FIG. 9 is a schematic flowchart of a reference signal configuration method provided in an embodiment of the present application;

FIG. 10 is a schematic structural diagram of a reference signal configuration apparatus provided in an embodiment of the present application;

FIG. 11 is a schematic structural diagram of a reference signal configuration apparatus provided by an embodiment of the present application;

FIG. 12 is a schematic structural diagram of another reference signal configuration apparatus provided by an embodiment of the present application;

FIG. 13 is a schematic structural diagram of a chip provided by an embodiment of the present disclosure.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the present application. Rather, they are merely examples of apparatus and methods consistent with some aspects of the embodiments of the present application as recited in the appended claims.

The terms used in the embodiments of the present application are only for the purpose of describing specific embodiments, and are not intended to limit the embodiments of the present application. The singular forms “a” and “the” used in the embodiments of the present application and the appended claims are also intended to include plural forms unless the context clearly indicates otherwise. It should also be understood that the term “and/or” as used herein refers to and includes any or all possible combinations of one or more of the associated listed items.

It should be understood that although terms such as first, second, and third may be used in the embodiments of the present application to describe various information, such information should not be limited to these terms. These terms are only used to distinguish information of the same type from one another. For example, without departing from the scope of the embodiments of the present application, first information may also be called second information, and similarly, second information may also be called first information. Depending on the context, the words “in case of” and “if” as used herein may be interpreted as “while” or “when” or “in response to determining.”

Embodiments of the present application are described in detail below, examples of which are illustrated in the accompanying drawings, where the same or similar reference numerals designate the same or similar elements throughout. The embodiments described below by referring to the drawings are exemplary, and are intended to explain the present application, and should not be construed as limiting the present application.

In order to better understand a reference signal configuration method disclosed in the embodiments of the present application, the communication system to which the embodiments of the present application apply is firstly described below.

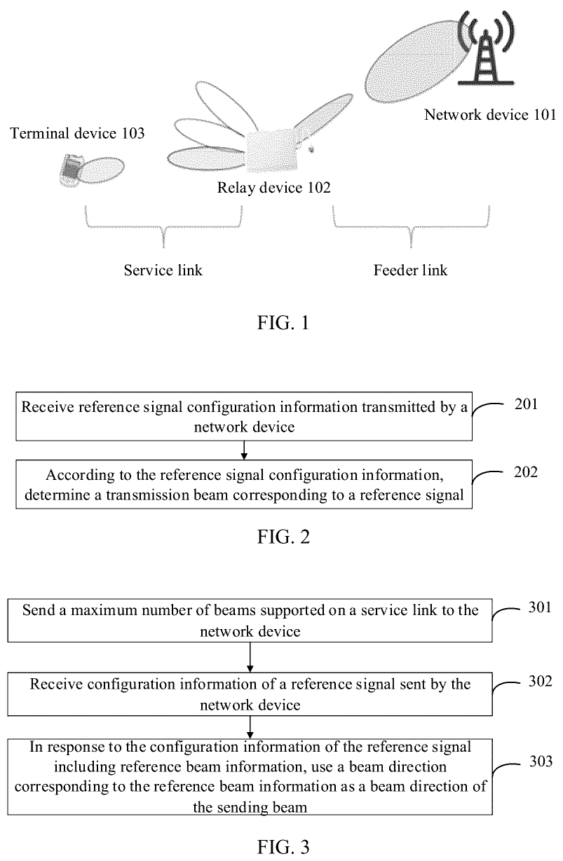

FIG. 1 is referred to, which is a schematic structural diagram of a communication system provided by an embodiment of the present application. The communication system may include, but is not limited to, one network device, one relay device, and one terminal device. The numbers and forms of the devices shown in FIG. 1 are for example only and do not constitute a limitation to the embodiments of the present application. In practical applications, two or more network devices, two or more relay devices, and two or more terminal devices may be included. The communication system shown in FIG. 1 includes one network device 101, one relay device 102 and one terminal device 103 as an example.

It should be noted that the technical solutions of the embodiments of the present application may be applied to various communication systems, for example: a Long Term Evolution (LTE) system, a fifth-generation mobile communication system, a 5G new radio system, or other future new mobile communication systems.

The network device 101 in the embodiments of the present application is an entity on the network side for transmitting or receiving signals. For example, the network device 101 may be an evolved base station (Evolved NodeB, eNB), a transmission point (Transmission Reception Point, TRP), a next-generation base station (Next Generation NodeB, gNB) in an NR system, a base station in other future mobile communication systems or an access node in a Wireless Fidelity (WiFi) system, etc. The embodiments of the present application do not limit the specific technology and specific device form adopted by the network device. The network device provided by the embodiments of the present application may be composed of a Central Unit (CU) and a Distributed Unit (DU), where the CU may also be called a Control Unit. The structure using CU-DU may separate the network device, such as the protocol layer of the base station. The functions of some protocol layers are placed in the CU to be controlled centrally, and the functions of the remaining part or all of the protocol layers are distributed in the DU, and the CU centrally controls the DU.

The relay device 102 in the embodiments of the present application is an entity added between the network side and the user side for forwarding signals one or more times. The relay device 102 may be a smart repeater, a decoding and forwarding relay, a layer 2 relay, a type 2 relay, a network unit, or may be a terminal device with a relay function, or a reconfigurable intelligence surface (RIS) and so on. The embodiments of the present application do not limit the specific technology and specific device form adopted by the relay device.

The terminal device 103 in the embodiments of the present application is an entity on the user side for receiving or transmitting signals, such as a mobile phone. The terminal device may also be called a terminal equipment (terminal), a user equipment (UE), a Mobile Station (MS), a Mobile Terminal (MT) and so on. The terminal device may be a car with a communication function, a smart car, a Mobile Phone, a wearable device, a tablet computer (Pad), a computer with a wireless transceiver function, a Virtual Reality (VR) terminal device, an Augmented Reality (AR) terminal device, a wireless terminal device in Industrial Control, a wireless terminal device in Self-Driving, a wireless terminal device in Remote Medical Surgery, a wireless terminal device in Smart Grid, a wireless terminal device in Transportation Safety, a wireless terminal device in Smart City, a wireless terminal device in Smart Home, etc. The embodiments of the present application do not limit the specific technology and specific device form adopted by the terminal device.

As shown in FIG. 1, the relay device 102 may perform beam sweeping on the service link to ensure that the terminal device 103 can search for a suitable beam. After the terminal device 103 founds the suitable beam, it may forward the feedback information to the network device 101 via the relay device 102, and the network device 101 demodulates the received signal to obtain the information fed back by the terminal device 103, and indicates which beam directions the relay device 102 needs to send on the service link according to the fed back information.

In the embodiments of the present application, by receiving the configuration information of the reference signal sent by the network device, and determining the beam corresponding to the reference signal according to the configuration information of the reference signal, a specific beam can be sent on the service link in the case that the network device does not directly indicate the beam forming angle to the relay device through signaling, which saves the overhead of additional signaling and improves the communication efficiency of the system.

It can be understood that the communication system described in the embodiments of the present application is to illustrate the technical solutions of the embodiments of the present application more clearly, and does not constitute a limitation to the technical solutions provided in the embodiments of the present application. The person skilled in the art may understand that with the evolution of the system architecture and the emergence of new service scenarios, the technical solutions provided in the embodiments of the present application are also applicable to similar technical problems.

The reference signal configuration method and apparatus thereof provided by the present application will be described in detail below with reference to the accompanying drawings.

FIG. 2 is referred to, which is a schematic flowchart of a reference signal configuration method provided in an embodiment of the present application. It should be noted that the reference signal configuration method in the embodiment of the present application is executed by a relay device. As shown in FIG. 2, the method may include the following steps.

In step 201, configuration information of a reference signal sent by a network device is received.

The reference signal (RS) may be an existing reference signal, such as a Sounding Reference Signal (SRS), or another new type of reference signal.

In some embodiments, the configuration information of the reference signal may be sent through a Radio Resource Control (RRC) signaling.

It should be noted that, in the embodiment of the present application, the configuration information of the reference signal is optional on the Uu interface, that is, the configuration information of the reference signal is only valid for the relay device or the terminal device supporting the relay function, and only the relay device or the terminal device supporting the relay function needs to be configured.

In some implementations, the configuration information of the reference signal includes reference beam information. The reference beam information is used to determine the beam corresponding to the reference signal.

In some implementations, the configuration information of the reference signal does not include the reference beam information.

Optionally, the configuration information of the reference signal includes a reference beam domain, and information in the reference beam domain is the reference beam information.

It can be understood that the reference beam domain may be empty, and if the reference beam domain is empty, it means that the configuration information of the reference signal does not include the reference beam information.

In step 202, according to the configuration information of the reference signal, a beam corresponding to the reference signal is determined.

In some implementations, the configuration information of the reference signal includes the reference beam information, and a beam direction corresponding to the reference beam information is used as a beam direction of the reference signal, that is, a direction of the beam corresponding to the reference signal.

Optionally, the reference beam information is direction vector information.

The direction vector information includes but not limited to beam direction angle information and a beamforming vector. The relay device can determine the beam direction of the beam corresponding to the reference signal according to the direction vector information.

Optionally, the reference beam information is a reference signal identifier.

Optionally, the identifier of the reference signal may be a Transmission Configuration Indicator (TCI) identifier or Spatial relation info, or a reference signal resource identifier, etc. For example, it may be channel state information reference signal resource identifier CRI (CSI-RS resource ID), sounding signal resource identifier SRI (SRS-resource ID) or synchronization signal (SS) block index (SSBI). Alternatively, the reference signal resource identifier may be configured in the TCI, the Downlink Control Information (DCI) includes the TCI, and D-type quasico-location (QCL) parameter qcl-type-D in the TCI corresponds to the reference signal resource identifier. The aforementioned reference signal may be one periodic reference signal, aperiodic reference signal or semi-static reference signal of RRC configuration, which is not limited in the present application.

The reference signal corresponding to the reference signal identifier is configured with corresponding direction vector information. The relay device can use the beam direction corresponding to the reference signal identifier as the beam direction of the reference signal according to the reference signal identifier.

In some implementations, the reference signal corresponding to the reference signal identifier is configured with a reference signal identifier, where the reference signal corresponding to the reference signal identifier is configured with corresponding direction vector information, and so on, the corresponding reference signal identifier may correspond to a certain reference signal identifier configured with direction vector information multiple times. The present application does not limit whether to use one correspondence or multiple correspondences.

In some implementations, the reference beam information is indication information.

The indication information is used to indicate direction vector information. The indication information may implicitly indicate the direction vector information, such as indicating a beamforming table or codebook predefined by a certain standard; another example is that the indication information indicates the beam number, and the relay device determines one beamforming table or codebook according to the beam number.

In some implementations, the configuration information of the reference signal does not include the reference beam information, and the direction of the beam corresponding to the reference signal is determined according to a beam forming strategy of the relay device.

The relay device determines the direction of the beam corresponding to the reference signal according to a predefined beam forming strategy. The relay device may determine different beamforming strategies according to different reference signals and different application scenarios. In the embodiment of the present application, the beamforming strategy and algorithm stored by the relay device itself are not specifically limited.

In the embodiment of the present application, the relay device may also send the maximum number of beams supported on the service link to the network device, so that the network device determines the number of reference signals that can be configured by the configuration information of the reference signal.

To sum up, by receiving the configuration information of the reference signal sent by the network device, and determining the beam corresponding to the reference signal according to the configuration information of the reference signal, a specific beam can be sent on the service link in the case that the network device does not directly indicate the beam forming angle to the relay device through signaling, which saves the overhead of additional signaling and improves the communication efficiency of the system.

FIG. 3 is referred to, which is a schematic flowchart of a reference signal configuration method provided in an embodiment of the present application. It should be noted that the reference signal configuration method in the embodiment of the present application is executed by a relay device. As shown in FIG. 3, the method may include the following steps.

In step 301, a maximum number of beams supported on a service link is sent to the network device.

The maximum number of beams supported refers to the maximum number of beams that the relay device can support on the service link, and is used by the network device to determine the number of reference signals configurable in the configuration information of the reference signal.

It can be understood that in the configuration information of the reference signal configured by the network device, the maximum number of configured reference signals is less than or equal to the maximum number of beams supported on the service link.

In some implementations, the relay device does not distinguish the beams of the service link and the feeder link, and the maximum number of beams supported on the service link is the maximum number of beams supported by the relay device.

In step 302, configuration information of a reference signal sent by the network device is received.

In the embodiment of the present application, step 302 may be implemented in any one of the embodiments of the present application, which is not limited in the embodiment of the present application, and will not be repeated here.

In step 303, in response to the configuration information of the reference signal including reference beam information, a beam direction corresponding to the reference beam information is used as a beam direction of the beam.

In some implementations, the configuration information of the reference signal includes a reference beam domain, and information in the reference beam domain is the reference beam information.

In some implementations, the reference beam information is direction vector information. The relay device directly generates the beam corresponding to the configured reference signal according to the reference beam information.

Optionally, the direction vector information includes, but is not limited to, beam direction angle information and a beamforming vector.

In some implementations, the reference beam information is a reference signal identifier.

Optionally, the identifier of the reference signal may be a Transmission Configuration Indicator (TCI) identifier or Spatial relation info, or a reference signal resource identifier, etc. For example, it may be channel state information reference signal resource identifier CRI (CSI-RS resource ID), sounding signal resource identifier SRI (SRS-resource ID) or synchronization signal block index (SSBI). Alternatively, the reference signal resource identifier may be configured in the TCI, the Downlink Control Information (DCI) includes the TCI, and D-type quasico-location (QCL) parameter qcl-type-D in the TCI corresponds to the reference signal resource identifier. The aforementioned reference signal may be one periodic reference signal, aperiodic reference signal or semi-static reference signal of RRC configuration, which is not limited by the present application.

The reference signal corresponding to the reference signal identifier is configured with corresponding direction vector information.

It should be noted that the reference signal corresponding to the reference signal identifier is a trained reference signal that has a one-to-one correspondence with the beam, that is, a reference signal configured with corresponding direction vector information. Therefore, there is a one-to-one correspondence between the reference signal identifier and the direction vector information. It can be understood that the reference signal corresponding to the reference signal identifier is not the reference signal configured by the configuration information of the reference signal in the embodiment of the present application.

The relay device can determine the direction vector information corresponding to the reference signal identifier according to the reference signal identifier, use the direction vector information as the beam direction of the beam corresponding to the currently configured reference signal, and generate a beam according to the direction vector information.

In some implementations, the relay device may sequentially use a plurality of beams corresponding to the set of reference beam information respectively. For example, after receiving the beam configuration sent by the network device, the relay device may determine that the sequence of the beams may be consistent with the sequence of the beam reference information in the RRC configuration according to the beam configuration. For another example, the configuration information also includes a corresponding relationship between the reference beam information and time information, and the smart relay device determines the sequence of sending beams according to the time information. The smart relay switches beams at each time unit, and the time unit may be a slot. The present application does not limit the granularity of the time unit.

Optionally, in the embodiment of the present application, the configuration information of the reference signal may also include at least one of a repetition domain repetition {on, off} or a sweeping domain sweep {on, off}. When repetition is on or when sweep is off, the relay device repeatedly sends beams in a specific direction. When repetition is off or sweep is on, the relay device performs beam sweeping.

To sum up, by sending the maximum number of beams supported on the service link to the network device, receiving the configuration information of the reference signal sent by the network device, and in response to the configuration information of the reference signal including reference beam information, using the beam direction corresponding to the reference beam information as the beam direction of the beam, a specific beam can be sent on the service link in the case that the network device does not directly indicates the beam forming angle to the relay device through signaling, which saves the overhead of additional signaling and improves the communication efficiency of the system.

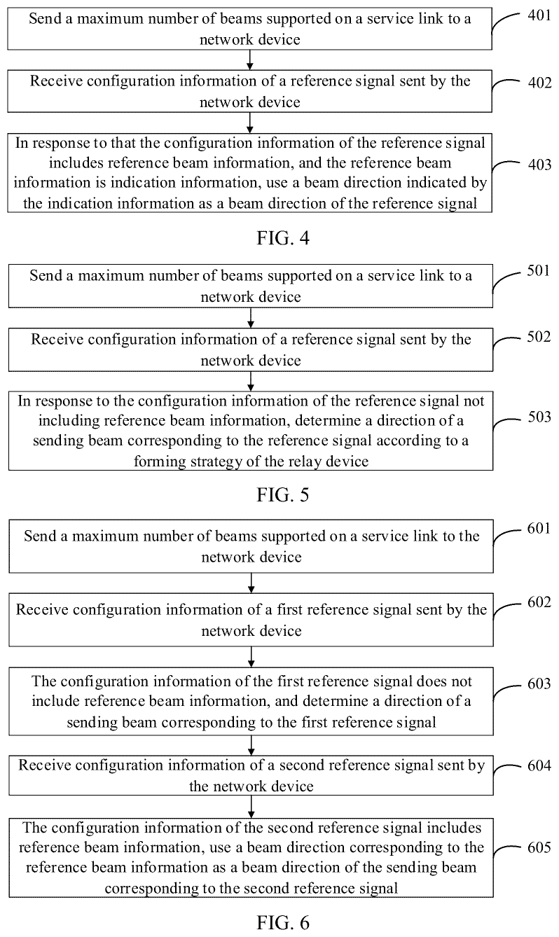

FIG. 4 is referred to, which is a schematic flowchart of a reference signal configuration method provided in an embodiment of the present application. It should be noted that, the reference signal configuration method in the embodiment of the present application is executed by a first network device. The relevant description about the first network device is as above, and will not be repeated here.

As shown in FIG. 4, the method may include the following steps.

In step 401, a maximum number of beams supported on a service link is sent to a network device.

In step 402, configuration information of a reference signal sent by the network device is received.

In the embodiment of the present application, step 401 and step 402 may be implemented in any of the embodiments of the present application respectively, which is not limited in the embodiment of the present application, and will not be repeated here.

In step 403, in response to that the configuration information of the reference signal includes reference beam information, and the reference beam information is indication information, a beam direction indicated by the indication information is used as a beam direction of the reference signal.

The indication information is used to indicate direction vector information. The indication information may implicitly indicate the direction vector information.

In some implementations, a corresponding relationship between a codebook or a beamforming table and the number of beams is predefined, and the indication information indicates the number of beams. For example, m beams correspond to codebook A or beamforming table A1, and n beams correspond to codebook B or beamforming table B1. It can be understood that the predefined corresponding relationship may be determined by both the relay device and the network device. The relay device may determine the corresponding codebook according to the number of beams indicated by the indication information, and determine the direction of the beam corresponding to the reference signal according to the codebook.

In some implementations, the indication information indicates a codebook identifier, and the relay device determines the direction of the beam corresponding to the reference signal according to the codebook corresponding to the indicated codebook identifier. The codebook is also predefined by a certain standard.

In some implementations, the relay device may sequentially use a plurality of beams corresponding to the set of reference beam information. For example, after receiving the beam configuration sent by the network device, the relay device may determine that the sequence of beams may be consistent with the sequence of the beam reference information in the RRC configuration according to the beam configuration. For another example, the configuration information also includes a corresponding relationship between the reference beam information and time information, and the smart relay device determines the sequence of sending beams according to the time information. The smart relay switches beams at each time unit, and the time unit may be a slot. The present application does not limit the granularity of the time unit.

Optionally, in the embodiment of the present application, the configuration information of the reference signal may further include at least one of a repetition domain repetition {on, off} or a sweeping domain sweep {on, off}. When repetition is on or sweep is off, the relay device repeatedly sends beams in a specific direction. When repetition is off or sweep is on, the relay device performs beam sweeping.

In summary, by sending the maximum number of beams supported on the service link to the network device, receiving the configuration information of the reference signal sent by the network device, and in response to the configuration information of the reference signal including reference beam information, and the reference beam information is indication information, using the beam direction indicated by the indication information as the beam direction of the reference signal, a specific beam can be sent on the service link in the case that the network device does not directly indicate the beam forming angle to the relay device through signaling, which saves the overhead of additional signaling and improves the communication efficiency of the system.

FIG. 5 is referred to, which is a schematic flowchart of a reference signal configuration method provided in an embodiment of the present application. It should be noted that the reference signal configuration method in the embodiment of the present application is executed by a relay device. As shown in FIG. 5, the method may include the following steps.

In step 501, a maximum number of beams supported on a service link is sent to a network device.

In step 502, configuration information of a reference signal sent by the network device is received.

In the embodiment of the present application, step 501 and step 502 may be implemented in any of the embodiments of the present application respectively, which is not limited in the embodiment of the present application, and will not be repeated here.

In step 503, in response to the configuration information of the reference signal not including reference beam information, a direction of a beam corresponding to the reference signal is determined according to a forming strategy of the relay device.

In some implementations, the configuration information of the reference signal includes a reference beam domain, and when the reference beam domain is empty, the configuration information of the reference signal does not include the reference beam information.

The relay device determines the direction of the beam corresponding to the reference signal according to the predefined beam forming strategy, and generates the beam of the reference signal. The relay device may determine different beamforming strategies according to different reference signals and different application scenarios. In the embodiment of the present application, the beamforming strategy and algorithm stored by the relay device itself are not specifically limited.

Optionally, in the embodiment of the present application, the configuration information of the reference signal may further include at least one of a repetition domain repetition {on, off} or a sweeping domain sweep {on, off}. When repetition is on or when sweep is off, the relay device repeatedly sends beams in a specific direction. When repetition is off or sweep is on, the relay device performs beam sweeping.

In summary, by sending the maximum number of beams supported on the service link to the network device, receiving the configuration information of the reference signal sent by the network device, and in response to that the configuration information of the reference signal does not include reference beam information, determining the direction of the beam corresponding to the reference signal according to the forming strategy of the relay device, a specific beam can be sent on the service link in the case that the network device does not directly indicate the angle of beam formation to the relay device through signaling, which saves the overhead of additional signaling and improves the communication efficiency of the system.

FIG. 6 is referred to, which is a schematic flowchart of a reference signal configuration method provided in an embodiment of the present application. It should be noted that the reference signal configuration method in the embodiment of the present application is executed by a relay device. As shown in FIG. 6, the method may include the following steps.

In step 601, a maximum number of beams supported on a service link is sent to the network device.

In step 602, configuration information of a first reference signal sent by the network device is received.

In the embodiment of the present application, step 601 and step 602 can be implemented in any of the embodiments of the present application respectively, which is not limited in the embodiment of the present application, and will not be repeated here.

In step 603, the configuration information of the first reference signal does not include reference beam information, and a direction of a beam corresponding to the first reference signal is determined.

As in the implementations in the various embodiments of the present application, the relay device may generate the beam corresponding to the first reference signal according to the received control signaling sent by the network device or a predefined forming strategy.

In some implementations, the configuration information of the first reference signal is used to instruct the relay device to send beams in all directions to perform beam sweeping.

In step 604, configuration information of a second reference signal sent by the network device is received.

The network device determines at least one target beam from the beams corresponding to the first reference signal according to the signal measurement information of the first reference signal, and writes the at least one target beam as reference beam information into the configuration information of the second reference signal.

In some implementations, the signal measurement information includes at least one of Reference Signal Received Power (RSRP), Reference Signal Receiving Quality (RSRQ), Signal-to-Interference plus Noise Ratio (SINR) or Received Signal Strength Indicator (RSSI).

In step 605, the configuration information of the second reference signal includes reference beam information, and a beam direction corresponding to the reference beam information is used as a beam direction of the beam corresponding to the second reference signal.

As in the implementations in the embodiments of the present application, the relay device may generate a beam corresponding to the second reference signal according to the reference beam information.

Optionally, in the embodiment of the present application, the configuration information of the reference signal may further include at least one of a repetition domain repetition {on, off} or a sweeping domain sweep {on, off}. When repetition is on or sweep is off, the relay device repeatedly sends beams in a specific direction. When repetition is off or sweep is on, the relay device performs beam sweeping.

To sum up, the maximum number of beams supported on the service link is sent to the network device, the configuration information of the first reference signal sent by the network device is received, the configuration information of the first reference signal does not include reference beam information, the direction of the beam corresponding to the first reference signal is determined, the configuration information of the second reference signal sent by the network device is received, the configuration information of the second reference signal includes reference beam information, and the beam direction corresponding to the reference beam information is used as the beam direction of the beam corresponding to the second reference signal. Therefore, a specific and suitable beam can be sent on the service link through RRC reconfiguration in the case that the network device does not directly indicate the angle of beam formation to the relay device through signaling, which saves the overhead of additional signaling and improve the communication efficiency of the system.

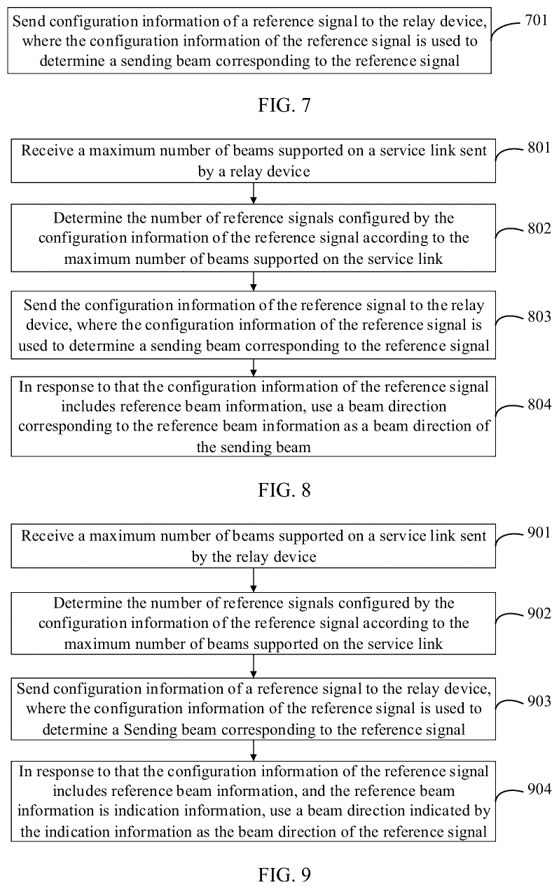

FIG. 7 is referred to, which is a schematic flowchart of a reference signal configuration method provided in an embodiment of the present application. It should be noted that the reference signal configuration method in the embodiment of the present application is executed by a network device. As shown in FIG. 7, the method may include the following steps.

In step 701, configuration information of a reference signal is sent to the relay device, where the configuration information of the reference signal is used to determine a beam corresponding to the reference signal.

The reference signal may be an existing reference signal, such as a sounding reference signal (SRS), or another new type of reference signal.

In some embodiments, the configuration information of the reference signal may be sent through radio resource control (RRC) signaling.

It should be noted that, in the embodiment of the present application, the configuration information of the reference signal is optional on the Uu interface, that is, the configuration information of the reference signal is only valid for the relay device or the terminal device supporting the relay function, and only the relay device or the terminal device supporting the relay function needs to be configured.

In some implementations, the configuration information of the reference signal includes reference beam information. The reference beam information is used to determine the beam corresponding to the reference signal.

In some implementations, the configuration information of the reference signal does not include the reference beam information.

Optionally, the configuration information of the reference signal includes a reference beam domain, and information in the reference beam domain is the reference beam information.

It can be understood that the reference beam domain may be empty, and if the reference beam domain is empty, it means that the configuration information of the reference signal does not include the reference beam information.

In some implementations, the configuration information of the reference signal includes the reference beam information, and a beam direction corresponding to the reference beam information is used as a beam direction of the beam.

Optionally, the reference beam information is direction vector information.

The direction vector information includes but not limited to beam direction angle information and a beamforming vector. The relay device can determine the beam direction of the beam corresponding to the reference signal according to the direction vector information.

Optionally, the reference beam information is a reference signal identifier.

Optionally, the identifier of the reference signal may be a Transmission Configuration Indicator (TCI) identifier or spatial relation info, or a reference signal resource identifier, etc. For example, it may be channel state information reference signal resource identifier CRI (CSI-RS resource ID), sounding signal resource identifier SRI (SRS-resource ID) or synchronization signal block index (SS block index, SSBI). Alternatively, the reference signal resource identifier may be configured in the TCI, the downlink control information (DCI) includes the TCI, and D-type quasico-location (QCL) parameter qcl-type-D in the TCI corresponds to the reference signal resource identifier. The aforementioned reference signal may be one periodic reference signal, aperiodic reference signal or semi-static reference signal of RRC configuration, which is not limited in the present application.

The reference signal corresponding to the reference signal identifier is configured with corresponding direction vector information. The relay device can use the beam direction corresponding to the reference signal identifier as the beam direction of the reference signal according to the reference signal identifier.

In some implementations, the reference signal corresponding to the reference signal identifier is configured with a reference signal identifier, where the reference signal corresponding to the reference signal identifier is configured with corresponding direction vector information, and so on, the corresponding reference signal identifier may correspond to a certain reference signal identifier configured with direction vector information multiple times. The present application does not limit whether to use one correspondence or multiple correspondences.

In some implementations, the reference beam information is indication information.

The indication information is used to indicate direction vector information. The indication information may implicitly indicate the direction vector information, such as indicating a beamforming table or codebook predefined by a standard; another example is that the indication information indicates the beam number, and the relay device determines one beamforming table or codebook according to the beam number.

In the embodiment of the application, the network device also receives the maximum number of supported beams on the service link sent by the relay device, and determines the number of reference signals configurable by the configuration information of the reference signal according to the maximum number of supported beams on the service link.

To sum up, by sending the configuration information of the reference signal to the relay device, the configuration information of the reference signal being used to determine the beam corresponding to the reference signal, a specific beam can be sent on the service link in the case that the network device does not directly indicate the angle of beam formation to the relay device through signaling, which saves the overhead of additional signaling and improves the communication efficiency of the system.

FIG. 8 is referred to, which is a schematic flowchart of a reference signal configuration method provided in an embodiment of the present application. It should be noted that the reference signal configuration method in the embodiment of the present application is executed by a network device. As shown in FIG. 8, the method may include the following steps.

In step 801, a maximum number of beams supported on a service link sent by a relay device is received.

The maximum number of supported beams refers to the maximum number of beams that the relay device can support on the service link, and is used for the network device to determine the number of reference signals configured by the configuration information of the reference signal.

It can be understood that, in the configuration information of the reference signal configured by the network device, the maximum number of configured reference signals is less than or equal to the maximum number of beams supported on the service link.

In some implementations, the relay device does not distinguish the beams of the service link and the feeder link, and the maximum number of beams supported on the service link is the maximum number of beams supported by the relay device.

In step 802, the number of reference signals configured by the configuration information of the reference signal is determined according to the maximum number of beams supported on the service link.

The maximum number of reference signals configured in the configuration information of the reference signal is less than or equal to the maximum number of beams supported on the service link.

In step 803, the configuration information of the reference signal is sent to the relay device, where the configuration information of the reference signal is used to determine a beam corresponding to the reference signal.

In the embodiment of the present application, step 803 may be implemented in any one of the embodiments of the present application, which is not limited in the embodiment of the present application, and will not be repeated here.

In step 804, in response to that the configuration information of the reference signal includes reference beam information, a beam direction corresponding to the reference beam information is used as a beam direction of the beam.

In some implementations, the configuration information of the reference signal includes a reference beam domain, and information in the reference beam domain is the reference beam information.

In some implementations, the reference beam information is direction vector information. The relay device directly generates the beam corresponding to the configured reference signal according to the reference beam information.

Optionally, the direction vector information includes, but is not limited to, beam direction angle information and a beamforming vector.

In some implementations, the reference beam information is a reference signal identifier.

Optionally, the identifier of the reference signal may be a Transmission Configuration Indicator (TCI) identifier or Spatial relation info, or a reference signal resource identifier, etc. For example, it may be channel state information reference signal resource identifier CRI (CSI-RS resource ID), sounding signal resource identifier SRI (SRS-resource ID) or synchronization signal block sequence number (SS block index, SSBI). Alternatively, the reference signal resource identifier may be configured in the TCI, the Downlink Control Information (DCI) includes the TCI, and D-type quasico-location (QCL) parameter qcl-type-D in the TCI corresponds to the reference signal resource identifier. The aforementioned reference signal may be one periodic reference signal, aperiodic reference signal or semi-static reference signal of RRC configuration, which is not limited by the present application.

The reference signal corresponding to the reference signal identifier is configured with corresponding direction vector information.

It should be noted that the reference signal corresponding to the reference signal identifier is a trained reference signal that has a one-to-one correspondence with the beam, that is, a reference signal configured with corresponding direction vector information. Therefore, there is a one-to-one correspondence between the reference signal identifier and the direction vector information. It can be understood that the reference signal corresponding to the reference signal identifier is not the reference signal configured by the configuration information of the reference signal in the embodiment of the present application.

The relay device can determine the direction vector information corresponding to the reference signal identifier according to the reference signal identifier, use the direction vector information as the beam direction of the beam corresponding to the currently configured reference signal, and generate a beam according to the direction vector information.

In some implementations, the relay device may sequentially use a plurality of beams corresponding to the set of reference beam information respectively. For example, after receiving the beam configuration sent by the network device, the relay device may determine that the sequence of the beams may be consistent with the sequence of the beam reference information in the RRC configuration according to the beam configuration. For another example, the configuration information also includes a corresponding relationship between the reference beam information and time information, and the smart relay device determines the sequence of sending beams according to the time information. The smart relay switches beams at each time unit, and the time unit may be a slot. The present application does not limit the granularity of the time unit.

Optionally, in the embodiment of the present application, the configuration information of the reference signal may also include at least one of a repetition domain repetition {on, off} or a sweeping domain sweep {on, off}. When repetition is on or sweep is off, the relay device repeatedly sends beams in a specific direction. When repetition is off or sweep is on, the relay device performs beam sweeping.

To sum up, by receiving the maximum number of beams supported on the service link sent by the relay device, determining the number of reference signals configured by the configuration information of the reference signal according to the maximum number of beams supported on the service link, sending the configuration information of the reference signal to the relay device, the configuration information of the reference signal being used to determine the beam corresponding to the reference signal, and in response to the configuration information of the reference signal including the reference beam information, using the beam direction corresponding to the reference beam information as the beam direction of the beam, a specific beam can be sent on the service link in the case that the network device does not directly indicate the beam forming angle to the relay device through signaling, which saves the overhead of additional signaling and improves the communication efficiency of the system.

FIG. 9 is referred to, which is a schematic flowchart of a reference signal configuration method provided in an embodiment of the present application. It should be noted that the reference signal configuration method in the embodiment of the present application is executed by a network device. As shown in FIG. 9, the method may include the following steps.

In step 901, the maximum number of beams supported on the service link sent by the relay device is received.

In step 902, the number of reference signals configured by the configuration information of the reference signal is determined according to the maximum number of beams supported on the service link.

In step 903, configuration information of a reference signal is sent to the relay device, where the configuration information of the reference signal is used to determine a beam corresponding to the reference signal.

In the embodiment of the present application, step 901, step 902 and step 903 can be implemented in any of the embodiments of the present application respectively, which is not limited in the embodiment of the present application, and will not be repeated here.

In step 904, in response to that the configuration information of the reference signal includes reference beam information, and the reference beam information is indication information, a beam direction indicated by the indication information is used as the beam direction of the reference signal.

The indication information is used to indicate direction vector information. The indication information may implicitly indicate the direction vector information.

In some implementations, a corresponding relationship between a codebook or a beamforming table and the number of beams is predefined, and the indication information indicates the number of beams. For example, m beams correspond to codebook A or beamforming table A1, and n beams correspond to codebook B or beamforming table B1. It can be understood that the predefined corresponding relationship may be determined by both the relay device and the network device. The relay device may determine the corresponding codebook according to the number of beams indicated by the indication information, and determine the direction of the beam corresponding to the reference signal according to the codebook.

In some implementations, the indication information indicates a codebook identifier, and the relay device determines the direction of the beam corresponding to the reference signal according to the codebook corresponding to the indicated codebook identifier. The codebook is also predefined by a certain standard.

Optionally, in the embodiment of the present application, the configuration information of the reference signal may further include at least one of a repetition domain repetition {on, off} or a sweeping domain sweep {on, off}. When repetition is on or sweep is off, the relay device repeatedly sends beams in a specific direction. When repetition is off or sweep is on, the relay device performs beam sweeping.

To sum up, the maximum number of beams supported on the service link sent by the relay device is received, the number of reference signals configured in the configuration information of the reference signal is determined according to the maximum number of beams supported on the service link, the configuration information of the reference signal is sent to the relay device, the configuration information of the reference signal being used to determine the beam corresponding to the reference signal, and in response to the configuration information of the reference signal including reference beam information, and the reference beam information being indication information, the beam direction indicated by the indication information is used as the beam direction of the reference signal. Therefore, a specific beam can be sent on the service link in the case that the network device does not directly indicate the angle of beam formation to the relay device through signaling, which saves the overhead of additional signaling and improves the communication efficiency of the system.

In order to understand the technical solutions of the present application more intuitively and clearly, the present application also provides the following exemplary implementations.

As an exemplary implementation, the relay device can distinguish the beam of the service link from the beam of the feeder link. For example, the relay device has two antenna panels (panels), one for the service link and one for the feeder link. In this case, the network device can directly configure the configuration information of the reference signal for the service link. The network device may send the configuration information of the reference signal through RRC signaling. The configuration information of the reference signal is used to configure one reference signal resource set, which includes a plurality of reference signal resources. The maximum number of the reference signal resources is the maximum number of beams supported on the service link sent by the relay device to the network device. The usage of the reference signal is beam management. The configuration information of the reference signal may also include a repetition domain repetition {on, off}. When repetition is off, the relay device performs beam sweeping on the reference signal resources in the configured reference signal resource set. The specific beam direction of the swept beam depends on the realization of the relay device, which can be realized by the method described in any of the above-mentioned embodiments. When repetition is on, the relay device repeats a specific beam in the configured reference signal resource set, and the specific beam direction depends on the RRC configuration.

As another exemplary implementation, the relay device cannot distinguish the beam of the service link from the beam of the feeder link, and the network device may determine the beam set and its configuration for the service link through two beam sweepings. First, the network device configures configuration information of a first reference signal, which is used to configure a first reference signal resource set, where the number of the reference signal resources is less than/equal to the maximum number of supported beams sent by the relay device to the network device. The configuration information of the first reference signal instructs the relay device to send beams in all directions. The network device determines a part of the target beams according to the detection results of at least one of RSRP or RSRQ of each reference signal resource, configures the target beams in configuration information of a second reference signal through RRC reconfiguration, and sends them to the relay device. The configuration information of the second reference signal may also include a sweeping domain sweep {on, off}. When sweep is on, the relay device sends specific beams in different directions on a specific time-frequency resource to perform beam sweeping. The direction of the beam is determined by the reference beam information in the configuration information of the reference signal in RRC. When the configuration information does not include the reference beam information, the direction of the beam is determined by the forming strategy of the relay device or a rule predefined in a standard. When sweep is off, the relay device sends a specific same beam at a specific time-frequency resource position.

Corresponding to the reference signal configuration methods provided in the above-mentioned several embodiments, the present application also provides a reference signal configuration apparatus. Since the reference signal configuration apparatus provided in the embodiments of the present application corresponds to the methods provided in the above-mentioned several embodiments, the implementations of the reference signal configuration method are also applicable to the reference signal configuration apparatus provided in the following embodiments, which will not be described in detail in the following embodiments.

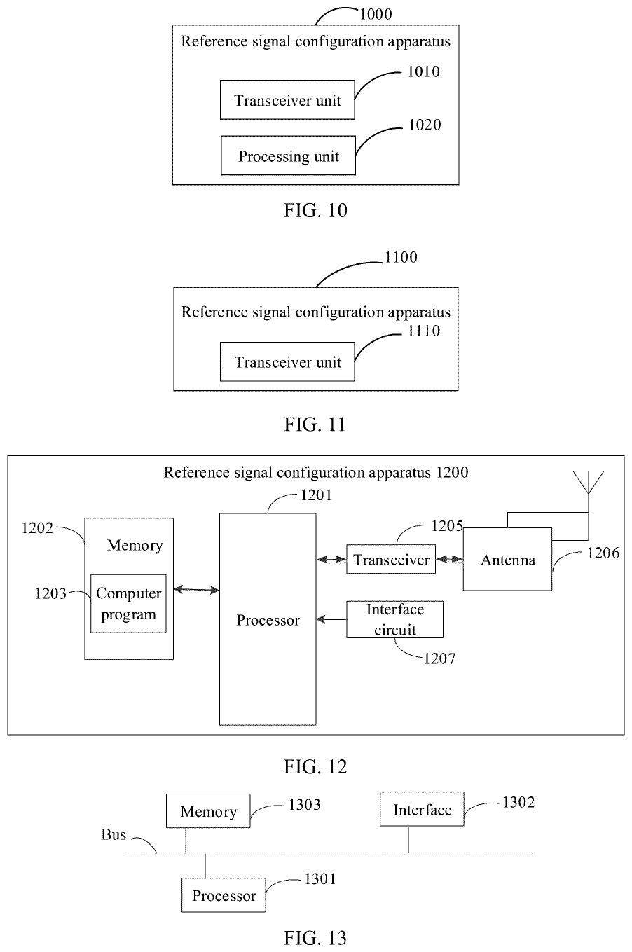

FIG. 10 is referred to, which is a schematic structural diagram of a reference signal configuration apparatus according to an embodiment of the present application.

As shown in FIG. 10, the reference signal configuration apparatus 1000 includes: a transceiver unit 1010, and a processing unit 1020.

The transceiver unit 1010 is configured to receive configuration information of a reference signal sent by a network device.

The processing unit 1020 is configured to determine a beam corresponding to the reference signal according to the configuration information of the reference signal.

Optionally, the processing unit 1020 is specifically configured to: in response to the configuration information of the reference signal including reference beam information, use a beam direction corresponding to the reference beam information as a beam direction of the beam.

Optionally, the reference beam information is direction vector information; where the direction vector information includes but not limited to beam direction angle information and a beamforming vector.

Optionally, the reference beam information is a reference signal identifier; where a reference signal corresponding to the reference signal identifier is configured with corresponding direction vector information.

Optionally, the reference beam information is indication information; where the indication information is used to indicate direction vector information.

Optionally, the processing unit 1020 is further configured to: in response to the configuration information of the reference signal not including the reference beam information, determine a direction of the beam corresponding to the reference signal according to a forming strategy of the relay device.

Optionally, the transceiver unit 1010 is further configured to: send a maximum number of beams supported on a service link to the network device, where the maximum number of beams supported on the service link is used for the network device to determine a number of reference signals configured by the configuration information of the reference signal.

Optionally, a maximum number of reference signals configured by the configuration information of the reference signal is less than or equal to the maximum number of beams supported on the service link.

The reference signal configuration apparatus in this embodiment can receive the configuration information of the reference signal sent by the network device, and determine the beam corresponding to the reference signal according to the configuration information of the reference signal, so that a specific beam can be sent on the service link in the case that the network device does not directly indicate the beamforming angle to the relay device through signaling, which saves the overhead of additional signaling and improves the communication efficiency of the system.

FIG. 11 is referred to, which is a schematic structural diagram of a reference signal configuration apparatus according to an embodiment of the present application.

As shown in FIG. 11, the reference signal configuration apparatus 1100 includes: a transceiver unit 1110.

The transceiver unit 1110 is configured to send configuration information of a reference signal to the relay device.

The configuration information of the reference signal is used to determine a beam corresponding to the reference signal.

Optionally, in response to the configuration information of the reference signal including reference beam information, a beam direction corresponding to the reference beam information is used as a beam direction of the beam.

Optionally, the reference beam information is direction vector information; where the direction vector information includes but not limited to beam direction angle information and a beamforming vector.

Optionally, the reference beam information is a reference signal identifier; where a reference signal corresponding to the reference signal identifier is configured with corresponding direction vector information.

Optionally, the reference beam information is indication information; where the indication information is used to indicate direction vector information.

Optionally, the transceiver unit 1110 is further configured to: receive a maximum number of beams supported on a service link sent by the relay device. The apparatus further includes a processing unit, configured to determine a number of reference signals configured by the configuration information of the reference signal according to the maximum number of beams supported on the service link.

Optionally, a maximum number of reference signals configured by the configuration information of the reference signal is less than or equal to the maximum number of beams supported on the service link.

The reference signal configuration apparatus in this embodiment can send configuration information of a reference signal to the relay device, and the configuration information of the reference signal is used to determine the beam corresponding to the reference signal, so that a specific beam can be sent on the service link in the case that the network device does not directly indicate to the relay device the beam forming angle through signaling, which saves the overhead of additional signaling and improves the communication efficiency of the system.

In order to realize the above-mentioned embodiments, the embodiment of the present application also proposes a communication apparatus, including: a processor and a memory, a computer program is stored in the memory, and the processor executes the computer program stored in the memory, so that the apparatus executes the methods shown in the embodiments of FIG. 2 to FIG. 6.

In order to realize the above-mentioned embodiments, the embodiment of the present application also proposes a communication apparatus, including: a processor and a memory, a computer program is stored in the memory, and the processor executes the computer program stored in the memory, so that the apparatus executes the methods shown in the embodiments of FIG. 7 to FIG. 9.

In order to realize the above-mentioned embodiments, the embodiment of the present application also proposes a communication apparatus, including: a processor and an interface circuit, the interface circuit is used to receive code instructions and transmit them to the processor, and the processor is used to run the code instructions to execute the methods shown in the embodiments of FIG. 2 to FIG. 6.

In order to realize the above-mentioned embodiments, the embodiment of the present application also proposes a communication apparatus, including: a processor and an interface circuit, the interface circuit is used to receive code instructions and transmit them to the processor, and the processor is used to run the code instructions to execute the methods shown in the embodiments of FIG. 7 to FIG. 9.

FIG. 12 is referred to, which is a schematic structural diagram of another reference signal configuration apparatus provided by an embodiment of the present disclosure. The reference signal configuration apparatus 1200 may be a network device, or a terminal device, or a chip, a chip system, a processor or the like that supports the network device to implement the above methods, or may be a chip, a chip system, a processor or the like that supports the terminal device to implement the above methods. The apparatus may be used to implement the methods described in the above method embodiments, and for details, the descriptions in the above method embodiments may be referred to.

The reference signal configuration apparatus 1200 may include one or more processors 1201. The processor 1201 may be a general-purpose processor or a special-purpose processor. For example, it may be a baseband processor or a central processing unit. The baseband processor may be used to process the communication protocol and communication data, and the central processor may be used to control the reference signal configuration apparatus (such as a base station, a baseband chip, a terminal device, a terminal device chip, a DU or a CU, etc.), execute the computer program and process data of the computer program.

Optionally, the reference signal configuration apparatus 1200 may further include one or more memories 1202, on which a computer program 1203 may be stored. The processor 1201 executes the computer program 1203, so that the reference signal configuration apparatus 1200 executes the methods described in the above method embodiments. The computer program 1203 may be solidified in the processor 1201, and in this case, the processor 1201 may be implemented by hardware.

Optionally, data may also be stored in the memory 1202. The reference signal configuration apparatus 1200 and the memory 1202 may be set separately or integrated together.

Optionally, the reference signal configuration apparatus 1200 may further include a transceiver 1205 and an antenna 1206. The transceiver 1205 may be called a transceiver unit, a transceiver machine, or a transceiver circuit, etc., and is used to implement a transceiver function. The transceiver 1205 may include a receiver and a transmitter. The receiver may be called a receiving machine or a receiving circuit for realizing a receiving function; and the transmitter may be called a transmitting machine or a sending circuit for realizing a sending function.

Optionally, the reference signal configuration apparatus 1200 may further include one or more interface circuits 1207. The interface circuit 1207 is used to receive code instructions and transmit them to the processor 1201. The processor 1201 executes the code instructions to enable the reference signal configuration apparatus 1200 to execute the methods described in the foregoing method embodiments.

In an implementation, the processor 1201 may include a transceiver for implementing receiving and sending functions. For example, the transceiver may be a transceiver circuit, or an interface, or an interface circuit. The transceiver circuits, interfaces or interface circuits for realizing the functions of receiving and sending may be separated or integrated together. The above-mentioned transceiver circuit, interface or interface circuit may be used for reading and writing code/data, or the above-mentioned transceiver circuit, interface or interface circuit may be used for signal transmission or transfer.

In an implementation, the reference signal configuration apparatus 1200 may include a circuit, and the circuit may implement the function of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The reference signal configuration apparatus described in the above embodiments may be a network device or a relay device, but the scope of the reference signal configuration apparatus described in the present disclosure is not limited thereto, and the structure of the reference signal configuration apparatus may not be limited by that shown in FIG. 10 to FIG. 11. The reference signal configuration apparatus may be a stand-alone device or may be part of a relatively large device. For example, the reference signal configuration means may be:
(1) a stand-alone integrated circuit (IC), or a chip, or a chip system or a subsystem;
(2) a set with one or more ICs, optionally, the set of ICs may also include a storage component for storing data and the computer program;
(3) ASIC, such as a Modem;
(4) a module that can be embedded in another device;
(5) a receiver, a terminal device, an intelligent terminal device, a cellular phone, a wireless device, a handset, a mobile unit, a vehicle device, a network device, a cloud device, an artificial intelligence device, etc.;
(6) others and so on.

For the case where the reference signal configuration apparatus may be a chip or a chip system, the schematic structural diagram of the chip shown in FIG. 13 may be referred to. The chip shown in FIG. 13 includes a processor 1301 and an interface 1302. The number of processors 1301 may be one or more, and the number of interfaces 1302 may be more than one.

For the case where the chip is used to realize the function of the relay device in the embodiment of the present disclosure:
the interface 1302 is configured to transmit code instructions to the processor;
the processor 1301 is configured to run the code instructions to execute the methods shown in FIG. 2 to FIG. 6.

For the case where the chip is used to realize the function of the network device in the embodiments of the present disclosure:
the interface 1302 is configured to transmit code instructions to the processor;
the processor 1301 is configured to run the code instructions to execute the methods shown in FIG. 7 to FIG. 9.

Optionally, the chip further includes a memory 1303 for storing necessary computer programs and data.

Those skilled in the art can also understand that various illustrative logical blocks and steps listed in the embodiments of the present disclosure can be implemented by an electronic hardware, computer software, or a combination of both. Whether such functions are implemented by hardware or software depends on the specific application and the design requirements of the overall system. Those skilled in the art may use various methods to implement the described functions for each specific application, but such implementation should not be understood as going beyond the protection scope of the embodiments of the present disclosure.

An embodiment of the present disclosure also provides a communication system, which includes the reference signal configuration apparatus as a relay device and the reference signal configuration apparatus as a network device in the aforementioned embodiments of FIG. 10 to FIG. 11, or, the system includes the reference signal configuration apparatus as a relay device and the reference signal configuration apparatus as a network device in the aforementioned embodiment of FIG. 12.

The present disclosure also provides a readable storage medium on which instructions are stored, and when the instructions are executed by a computer, the functions of any one of the above method embodiments are realized.

The present disclosure also provides a computer program product, which implements the functions of any one of the above method embodiments when executed by a computer.

In the above embodiments, all or part of them may be implemented by software, hardware, firmware or any combination thereof. When implemented using software, it may be implemented in whole or in part in the form of a computer program product. The computer program product includes one or more computer programs. When the computer program is loaded and executed on the computer, all or part of the processes or functions according to the embodiments of the present disclosure are generated. The computer can be a general-purpose computer, a special-purpose computer, a computer network, or other programmable apparatuses. The computer program can be stored in the computer-readable storage medium or transmitted from one computer-readable storage medium to another computer-readable storage medium, for example, the computer program can be transmitted from one website, computer, server or data center to another website site, computer, server or data center by wired (such as a coaxial cable, an optical fiber, a digital subscriber line (DSL)) or wireless (such as infrared, wireless, microwave, etc.) manner. The computer-readable storage medium may be any available medium that can be accessed by a computer, or a data storage device such as a server or a data center integrated with one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can understand that the first, second, and other numbers involved in the present disclosure are only for convenience of description, and are not used to limit the scope of the embodiments of the present disclosure, and also indicate the sequence.

At least one in the present disclosure can also be described as one or more, and a plurality of can be two, three, four or more, which is not limited in the present disclosure. In the embodiments of the present disclosure, for a technical feature, the technical features are distinguished by “first”, “second”, “third”, “A”, “B”, “C” and “D”, etc. The technical features described by the “first”, “second”, “third”, “A”, “B”, “C” and “D” have no sequence or order of magnitude therebetween.

The corresponding relationships shown in the tables in the present disclosure can be configured or predefined. The values of the information in each table are just examples, and may be configured as other values, which are not limited in the present disclosure. When configuring the corresponding relationship between the information and each parameter, it is not necessarily required to configure all the corresponding relationships shown in the tables. For example, in the table in the present disclosure, the corresponding relationship shown in some rows may not be configured. For another example, appropriate deformation adjustments can be made based on the above tables, for example, splitting, merging, and so on. The names of the parameters shown in the titles of the above tables may also adopt other names understandable by the communication apparatus, and the values or representations of the parameters may also be other values or representations understandable by the communication apparatus. When the above tables are implemented, other data structures can also be used, for example, arrays, queues, containers, stacks, linear tables, pointers, linked lists, trees, graphs, structures, classes, heaps, hashtables or hash tables.

The predefining in the present disclosure can be understood as defining, defining in advance, storing, pre-storing, pre-negotiating, pre-configuring, curing, or pre-firing.

Those skilled in the art can appreciate that the units and algorithm steps of the examples described in conjunction with the embodiments disclosed herein can be implemented by an electronic hardware, or a combination of computer software and the electronic hardware. Whether these functions are executed by hardware or software depends on the specific application and design constraints of the technical solution. Skilled artisans may implement the described functions using different methods for each particular application, but such implementation should not be considered as going beyond the scope of the present disclosure.

Those skilled in the art can clearly understand that for the convenience and brevity of the description, the specific working process of the above-described system, apparatus and unit may refer to the corresponding process in the foregoing method embodiments, which will not be repeated here.

It should be understood that the steps may be reordered, added or deleted using the various forms of flow shown above. For example, the steps described in the embodiments of the present disclosure may be executed in parallel, sequentially, or in a different order, which is not limited by the present disclosure, as long as the desired result of the technical solution disclosed in the present disclosure can be achieved.

The above specific implementations do not constitute a limitation to the protection scope of the present disclosure. It should be apparent to those skilled in the art that various modifications, combinations, sub-combinations and substitutions may be made depending on design requirements and other factors. Any modifications, equivalent replacements and improvements made within the spirit and principles of the present disclosure shall be included within the protection scope of the present disclosure.

1. A reference signal configuration method, wherein the method is performed by a relay device, and the method comprises:
receiving configuration information of a reference signal sent by a network device; and
determining a beam corresponding to the reference signal according to the configuration information of the reference signal.

2. The method according to claim 1, wherein determining the beam corresponding to the reference signal according to the configuration information of the reference signal comprises:
in response to the configuration information of the reference signal comprising reference beam information corresponding to the reference signal, using a beam direction corresponding to the reference beam information as a beam direction of the beam corresponding to the reference signal.

3. The method according to claim 2, wherein the reference beam information is direction vector information;
wherein the direction vector information comprises but not limited to beam direction angle information and a beamforming vector.

4. The method according to claim 2, wherein the reference beam information is a reference signal identifier;
wherein a reference signal corresponding to the reference signal identifier is configured with corresponding direction vector information.

5. The method according to claim 2, wherein the reference beam information is indication information;
wherein the indication information is used to indicate direction vector information.

6. The method according to claim 2, further comprising:
in response to the configuration information of the reference signal not comprising the reference beam information, determining a direction of the beam corresponding to the reference signal according to a forming strategy of the relay device.

7. The method according to claim 1, further comprising:
sending a maximum number of beams supported on a service link to the network device, wherein the maximum number of beams supported on the service link is used by the network device to determine a number of reference signals configured by the configuration information of the reference signal.

8. The method according to claim 7, wherein a maximum number of the reference signals configured by the configuration information of the reference signal is less than or equal to the maximum number of beams supported on the service link.

9. A reference signal configuration method, wherein the method is performed by a network device, and the method comprises:
sending configuration information of a reference signal to a relay device;
wherein the configuration information of the reference signal is used to determine a beam corresponding to the reference signal.

10. The method according to claim 9, wherein
in response to the configuration information of the reference signal comprising reference beam information corresponding to the reference signal, using a beam direction corresponding to the reference beam information as a beam direction of the beam corresponding to the reference signal.

11. The method according to claim 10, wherein
the reference beam information is direction vector information;
wherein the direction vector information comprises but not limited to beam direction angle information and a beamforming vector.

12. The method according to claim 10, wherein
the reference beam information is a reference signal identifier;
wherein a reference signal corresponding to the reference signal identifier is configured with corresponding direction vector information.

13. The method according to claim 10, wherein
the reference beam information is indication information;
wherein the indication information is used to indicate direction vector information.

14. The method according to claim 9, further comprising:
receiving a maximum number of beams supported on a service link sent by the relay device;
determining a number of reference signals configured by the configuration information of the reference signal according to the maximum number of beams supported on the service link.

15. The method according to claim 14, wherein a maximum number of the reference signals configured by the configuration information of the reference signal is less than or equal to the maximum number of beams supported on the service link.

16. A reference signal configuration apparatus, wherein the apparatus is applied to a relay device, and the apparatus comprises: a processor and a memory, a computer program is stored in the memory, and the processor executes the computer program stored in the memory to:
receive configuration information of a reference signal sent by a network device; and
determine a beam corresponding to the reference signal according to the configuration information of the reference signal.

17. The apparatus according to claim 16, wherein the processor is further configured to:
in response to the configuration information of the reference signal comprising reference beam information corresponding to the reference signal, use a beam direction corresponding to the reference beam information as a beam direction of the beam corresponding to the reference signal.

18. The apparatus according to claim 17, wherein
the reference beam information is direction vector information;
wherein the direction vector information comprises but not limited to beam direction angle information and the beamforming vector.

19. The apparatus according to claim 17, wherein
the reference beam information is a reference signal identifier;
wherein a reference signal corresponding to the reference signal identifier is configured with corresponding direction vector information.

20.-23. (canceled)

24. A reference signal configuration apparatus, wherein the apparatus is applied to a network device, and the apparatus comprises: a processor and a memory, a computer program is stored in the memory, and the processor executes the computer program stored in the memory to perform the reference signal configuration method according to claim 9.

25.-36. (canceled)
